(19) United States
(12) Patent Application Publication
(10) Pub. No.: US 2020/0013422 A1
(43) Pub. Date: Jan. 9, 2020

(54) System, Method, and Apparatus for Morphing of an Audio Track

(71) Applicant: Ralph W. Matkin, St. Petersburg, FL (US)

(72) Inventor: Ralph W. Matkin, St. Petersburg, FL (US)

(21) Appl. No.: 16/026,526

(22) Filed: Jul. 3, 2018

(51) Int. Cl. G10L 21/013; G10L 21/0232

(52) U.S. Cl. CPC G10L 21/013; G10L 2021/0135; G10L 21/0232

(57) ABSTRACT

A system for morphing an audio track includes a processor and software running on the processor. The software obtains target audio containing voice samples of a target voice and the software analyzes the target audio to create a target library. After the software creates the target library, the software loads a source audio file and, using the target library, the software morphs a voice from the source audio file into a morphed voice of the target voice, replacing the voice from the source file with the morphed voice of the target voice, creating a morphed audio file. The software then saves the morphed audio file into a storage associated with the processor.

### FIELD

This invention relates to the field of entertainment and more particularly to a system for morphing a vocal track to sound like a different person.

### BACKGROUND

People are often entertained by listening to music. Many know the words to songs and enjoy singing along, their voice blending with the original singer(s).

Karaoke is one way for people to sing along to a popular song, but the vocal track of the original singer (or lead singer) is removed or toned down so the person singing along becomes the lead singer. Karaoke has become a world-wide success, entertaining thousands in their homes or in establishments that offer Karaoke to patrons.

Modern music is typically produced using audio equipment the records vocals and instruments on independent tracks, and then the tracks are mixed by a sound engineer into the final song that we buy or hear through various deliver mechanisms. As the vocal(s) are typically on a separate track, it is relatively easy to suppress that track to produce the same song without the vocals for Karaoke sing-a-long. Even if the individual tracks are not available, one is able to suppress the vocal portion of the music through digital or analog filtering of the song in a frequency range that encompasses the singer's voice. The latter is useful for older music, as the original recorded tracks are not always available.

All of this is good if a person wants to sing along with the Karaoke song, but what if a person just wants to hear what the song would sound like if the (lead) singer had the person's voice? Or, what if one wishes to hear what a song would sound like if it was sung by a different artist. For example, what if one wants to hear what it would sound like if Steve Tyler sang “Let it Be?” There are currently no tools available to superimpose a voice onto a vocal track, or in other words, to morph a singer's voice using another person's vocal characteristics.

What is needed is a system that will morph a singer's voice by using another person's vocal characteristics.

### SUMMARY

In one embodiment, a system for morphing an audio track is disclosed including a processor and software running on the processor. The software obtains target audio containing voice samples of a target voice and the software analyzes the target audio to create a target library. After the software creates the target library, the software loads a source audio file and, using the target library, the software morphs a voice from the source audio file into a morphed voice of the target voice, replacing the voice from the source file with the morphed voice of the target voice, creating a morphed audio file. The software then saves the morphed audio file into a storage associated with the processor.

In another embodiment, method of morphing a source audio file is disclosed including analyzing a target voice to create a target library and then finding a voice within a source audio file. The voice is morphed using the target library so that the voice sounds like the target voice to create a morphed audio file. Then, saving the morphed audio file.

In another embodiment, program instructions tangibly embodied in a non-transitory storage medium of a computer for morphing a source audio file into a morphed audio file is disclosed including at least one instruction that includes computer readable instructions running on the computer that analyze a target voice to create a target library and the computer readable instructions running on the computer finds a voice within the source audio file and morphs the voice using the target library so that the voice sounds like the target voice to create a morphed audio file. The computer readable instructions running on the computer then saves the morphed audio file.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for morphing audio.

FIG. 2 illustrates a schematic view of a typical smartphone.

FIG. 3 illustrates a schematic view of a typical computer system such as a server or personal computer.

FIG. 4 illustrates a portion of an audio wave from a source audio file.

FIG. 5 illustrates a sample of an audio wave from a target voice (e.g. a user's voice).

FIG. 6 illustrates the same portion of the audio wave from a source audio file.

FIG. 7 illustrates the audio wave morphed by the system for morphing audio to resemble the target voice.

FIG. 8 illustrates a block diagram of the system for morphing audio.

FIG. 9 illustrates an exemplary program flow of the system for morphing audio.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this document, the term “target voice” refers to a voice that is analyzed. During this analysis, vocal characteristics of the target voice are extracted for later use in morphing audio from another source.

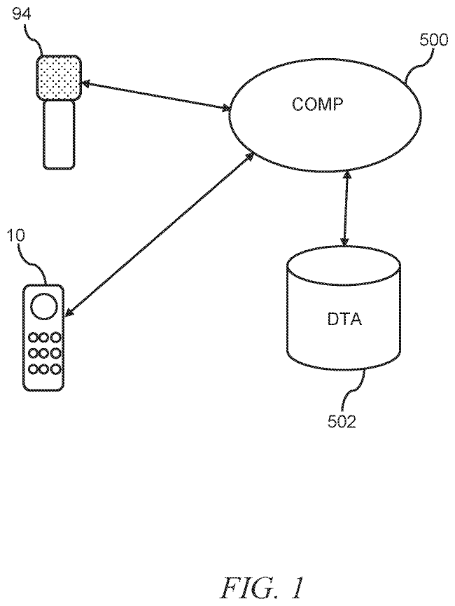

Referring to FIG. 1 illustrates a data connection diagram of the exemplary system for morphing audio. In this example, one or more smart devices such as smartphones 10 or a microphone 94 are used to capture voice samples from a user of the system for morphing audio. As will be discussed, the samples 310 of the target voice (see FIG. 8) are analyzed and used to morph a source audio file 300 (see FIG. 8) into a morphed audio file 300A (see FIG. 8).

The samples 310 of the target voice, source audio file 300, and morphed audio file 300A are typically stored in a user data area 502 that is accessible by the computer 500.

Throughout this description, embodiments are shown in which the samples 310 of the target voice are captured (e.g. a wave file is created from the person talking or singing) and stored, though it is fully anticipated that in some embodiments, a pre-recorded sample of the of the target voice be supplied instead. Likewise, throughout this description, embodiments are shown in which the source audio files 300 are provided from storage (e.g. MP3 files or Wave files), though, in some embodiments, the existing audio is provided directly, for example, from a live event.

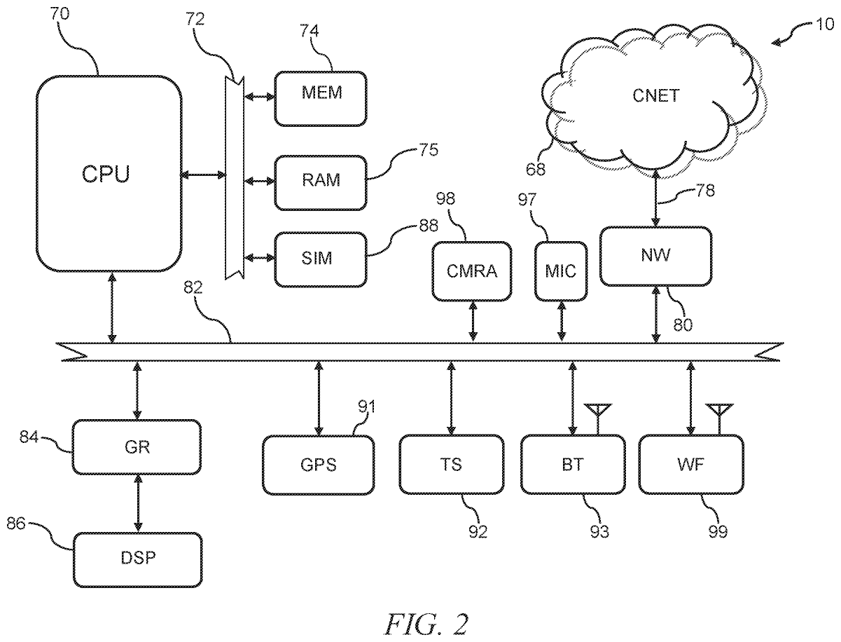

Referring to FIG. 2, a schematic view of a typical smart device, a smartphone 10 is shown though other portable (wearable or carried with a person) end-user devices such as tablet computers, smart watches 11, personal fitness devices, etc., are fully anticipated. Although any end-user device is anticipated, for clarity purposes, a smartphone 10 will be used in the remainder of the description as a smartphone 10 typically has a high quality microphone 97 (see FIG. 2).

The example smartphone 10 represents a typical device used for acquiring samples of the of the target voice in the system for morphing audio. This exemplary smartphone 10 is shown in one form with a sample set of features. Different architectures are known that accomplish similar results in a similar fashion and the present invention is not limited in any way to any particular smartphone 10 system architecture or implementation. In this exemplary smartphone 10, a processor 70 executes or runs programs in a random-access memory 75. The programs are generally stored within a persistent memory 74 and loaded into the random-access memory 75 when needed. Also accessible by the processor 70 is a SIM (subscriber information module) card 88 having a subscriber identification and often persistent storage. The processor 70 is any processor, typically a processor designed for phones. The persistent memory 74, random-access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary smartphones 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the SIM card 88 is used to store programs, executable code, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, camera 98, microphone 97, Bluetooth transceiver 93, Wi-Fi transceiver 99, image sensors, temperature sensors, etc., the details of which are not shown for brevity and clarity reasons. One feature of the Bluetooth transceiver and the Wi-Fi transceiver 99 is a unique address that is encoded into transmissions that is used to uniquely correlate between the smart device (smartphone 10) and the user.

The cellular network interface 80 connects the smartphone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the smartphone 10 through the cellular network 68.

For local communications, many smartphones 10 include a Bluetooth transceiver 93, a Wi-Fi transceiver 99, or both. Such features of smartphones 10 provide data communications between the smartphones 10 and other computers.

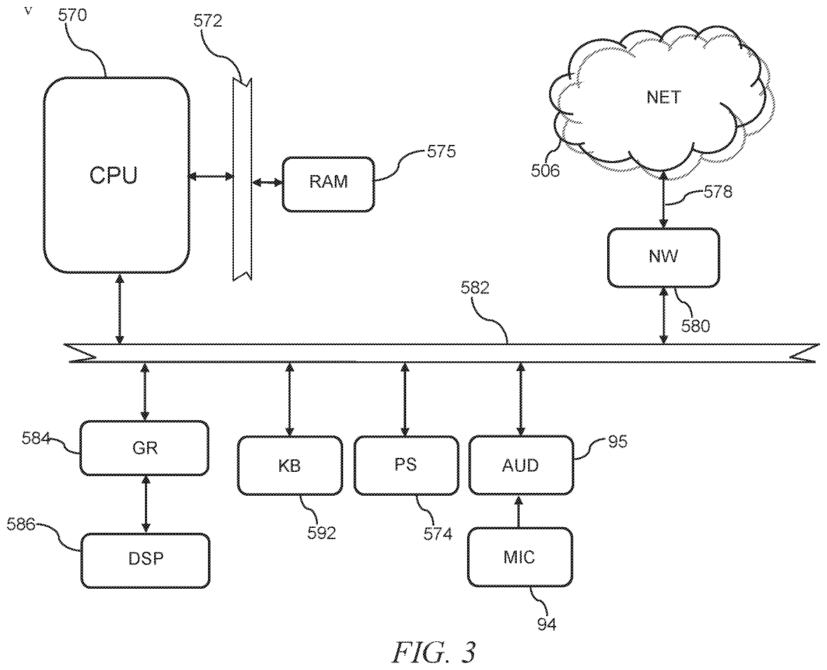

Referring to FIG. 3, a schematic view of a typical computer system 500 is shown. The example computer system 500 represents a typical computer system used in the system for morphing audio for capturing/reading the sample 310 of the of the target voice, processing the sample 310, reading the source audio file 300 and morphing the source audio file 300 into the morphed audio file 310A. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 (e.g., disk storage) is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, data, and other data, etc.

The peripherals are examples and other devices are known in the industry such as pointing devices, touch-screen interfaces, speakers, audio input circuits 95 for receiving and digitizing audio from microphones 94, USB interfaces, Wi-Fi transceivers, image sensors, temperature sensors, etc., the details of which are not shown for brevity and clarity reasons.

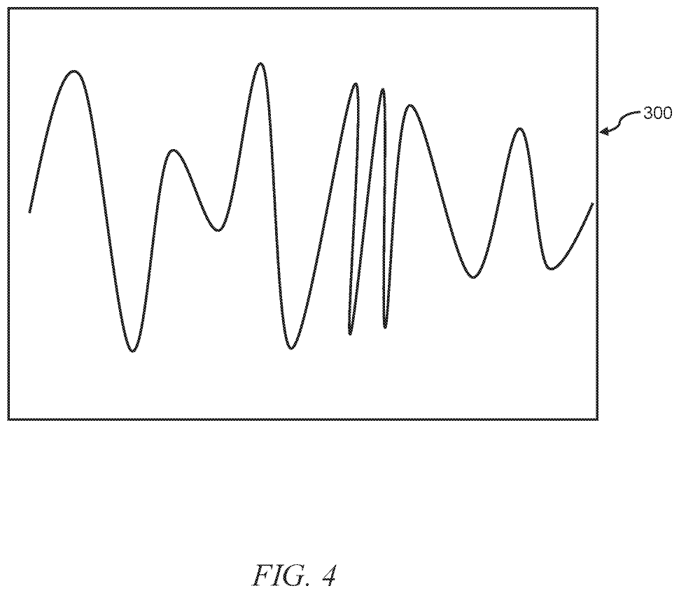

Referring to FIG. 4, a portion of an audio wave of a source audio file 300 is shown. As shown, the audio wave of the source audio file is very smooth with various amplitudes (height of the audio wave) and frequencies (density of the audio wave) as, perhaps, recorded by a famous singer. Each note that the singer sings has a frequency and amplitude dependent upon that singer's capabilities and the parameters of the song that is being sung (or verse that is being read, etc.). For example, even though a particular singer has the vocal amplitude to sing opera, that singer will sing a particular song or part of a song with a gentile, quiet voice (low amplitude). Each singer/orator emits a volume, frequency range, volume at each individual frequency, level of smoothness, that is unique to that singer, making that singer's voice easily recognizable and enjoyable to those who like that singer. Further, often a singer's upbringing provides for a dialect that is also detectable when listening to that singer's songs. For example, a British singer may sound British and a French singer may sound French. In such, often certain words are pronounced differently.

All of these nuances are present in the audio wave of a source audio file 300 of that singer, a very small sample of which is shown in FIG. 4.

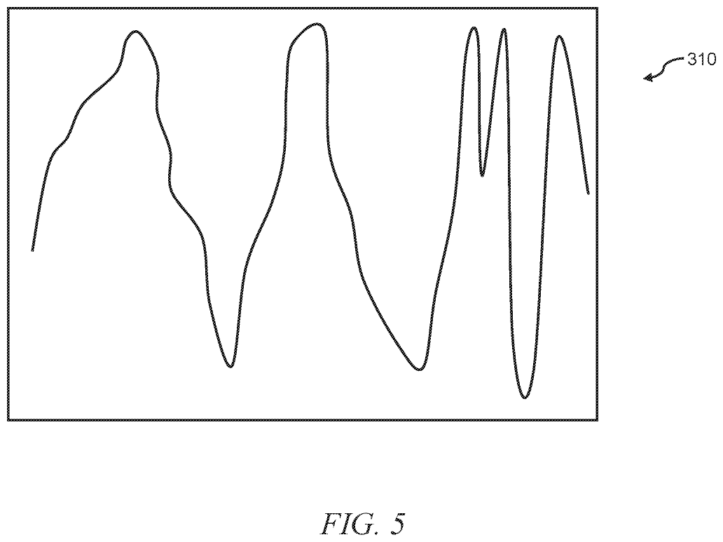

Referring to FIG. 5 a portion of an audio wave of a sample 310 of a target voice is shown. Like the audio wave of a source audio file 300, the sample 310 of the target voice has various amplitudes (height of the audio wave) and frequencies (density of the audio wave) as, captured, for example, from a microphone 94. Each note that the user sings/says in creating the sample 310 of the target voice has a frequency and amplitude dependent upon the user's capabilities when singing a sample song (or reading a sample verse, etc.). Each user emits a volume, frequency range, volume at each individual frequency, level of smoothness, that is unique to that user, making that user's voice unique and likely different than that of the singer of the source audio file 300. Further, often the user's upbringing provides for a dialect that is also detectable when listening to that user's voice. For example, a British user may sound British and a French user may sound French. In such, often certain words are pronounced differently.

Note that the waveform of the sample 310 of the target voice has a relatively constant volume (height) that indicates little vocal range and the lines of the waveform are not smooth. Perhaps this user smokes or their voice warbles.

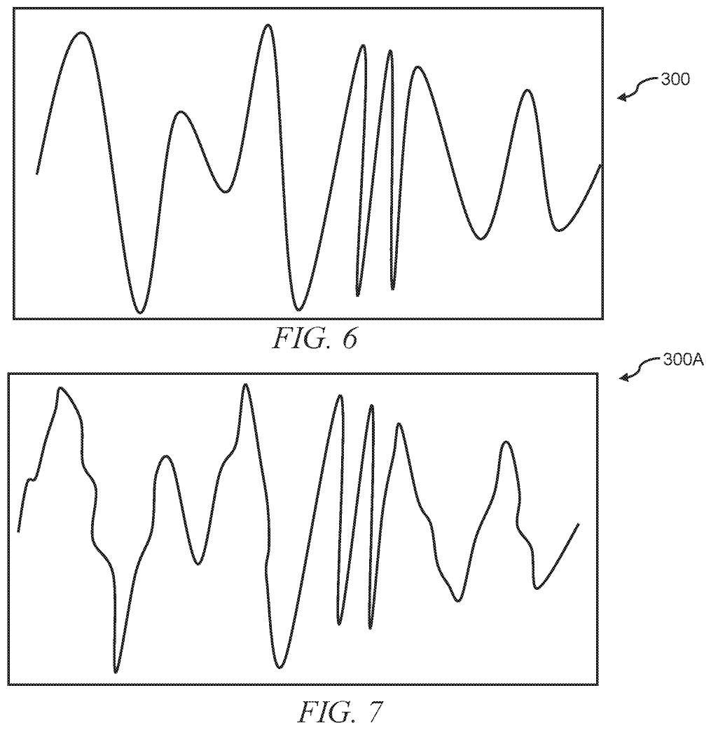

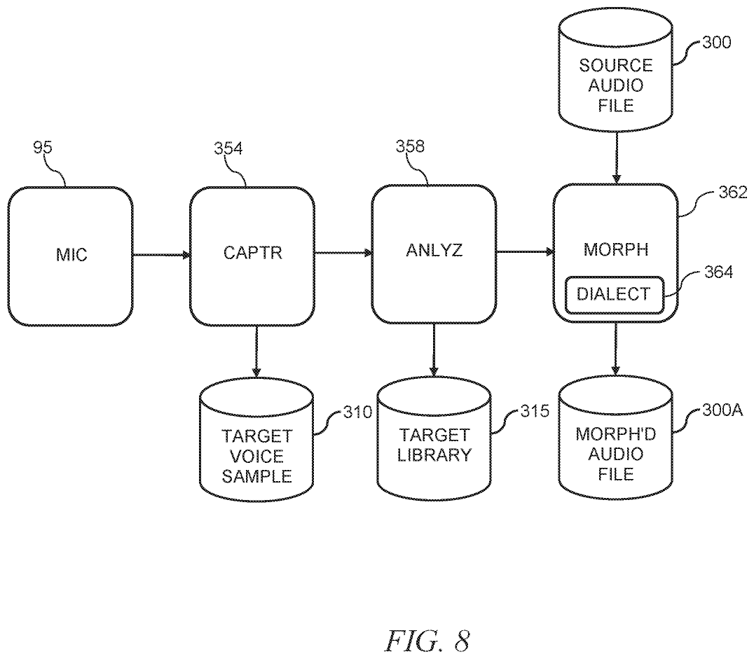

Referring to FIG. 6 a portion of an audio wave of a source audio file 300 is shown again (as in FIG. 4) for reference against the morphed audio file 300A that is shown below in FIG. 7. In FIG. 7, an audio wave of the morphed audio file 300A is shown. The audio wave of the source audio file 300 is processed using signals derived from the sample 310 of the target voice into the morphed audio file 300A by the system for morphing audio and, as shown, the morphed audio file 300A has at least some of characteristics of the sample 310 of the target voice. The waveforms of the morphed audio file 300A generally follows the cyclic patterns of the source audio file 300 mimicking the words spoken/sang at similar frequencies and amplitudes, though amended to include nuances for the sample 310 of the target voice. Therefore, instead of having the smooth waveforms of the source audio file 300, the morphed audio file 300A has waveforms that simulate those of the sample 310 of the target voice.

Referring now to FIG. 8, a block diagram of the system for morphing audio is shown. In this, the sample 310 of the target voice is captured by a capture module 354 and stored as the shown as the sample 310 of the target voice, for example in the user data area 502 or any suitable storage.

In some embodiments, instead of capturing a sample 310 of the target voice, the sample 310 of the target voice is an existing audio file. In such, it is possible to use a sample 310 of the target voice of one artist to morph a song that was originally sung by another artist. For example, one could see what it would have sounded like if Paul sang Yellow Submarine instead of Ringo. . . .

It is fully anticipated that the capture module 354 will accept free-form audio as the sample 310 of the target voice or, for greater accuracy, the capture module 354 will provide prompts to whoever is supplying the target voice that will better capture certain nuances of the target voice. For example, in some embodiments, the capture module 354 presents a tone representing a note and asks whoever is supplying the target voice to sing “do, re, me, fa, so, la, ti, do.” As another example, the capture module 354 requests that whoever is supplying the target voice to read a passage or sing a line from a well-known song. In reading the passage, certain idiomatic phrases are anticipated to determine the ethnicity of the target voice. For example, if the word “about” is included, it will be easier to determine if the target voice is American or Canadian while if the words “you all” are included, it will be easier to determine if the target voice is from one who lives in the southeastern United States, etc.

Once the sample 310 of the target voice is captured by the capture module 354, the sample 310 of the target voice is processed by an analysis module 358 to create a target library 315 that contains entries for various vocal parameters such as tonal quality, distortion, fuzziness, frequency range, amplitude range, mean/mode of typical vocal frequency range and amplitude range, measured target dialect, pronunciations, etc. In some embodiments, digital signal processing is used to by the analysis module 358 analyze the sample 310 of the target voice and produce entries in the target library 315.

For example, if the target voice is raspy, entries in the target library will indicate a raspy target voice. In another example, if the word “roof” is spoken as “ruf” in the target voice, then an entry in the target library will indicate to map “roof” to “ruf,” etc.

Once the sample 310 of the target voice is analyzed by the capture module 354 and the target library 315 is populated, then one or more source audio files 300 are morphed into one or more morphed audio files 300A by the morphing module 362. The morphing module 362 uses entries in the target library 315 to morph the source audio files 300 into morphed audio files 300A. For example, if an entry in the target library 315 indicates that the target voice has a certain level of raspy, then the morphing module 362 injects a similar amount of raspy into the waveforms from the source audio files 300 in creating the morphed audio file 300A. As another example, if the target library 315 indicates that the target voice has a certain frequency range (e.g. amplitude at a sweep of all audio frequencies), then the morphing module 362 will look for frequencies in which the target voice has lower amplitudes and reduce the amplitudes of those frequencies from the waveforms of the source audio files 300 in creating the morphed audio file 300A.

In some embodiments, the source audio file 300 contains voices of multiple contributors as well as musical instruments, background noise, etc. In such, the morphing module 362 determines which waveforms are directly related to the voice that is to be morphed and the morphing module only morphs the waveforms of that voice to sound like the target voice. In some embodiments, when the morphing module 362 recognizes that there is more than one voice in the source audio file 300, the morphing module 362 requests a user select which of the voices is to be morphed or the morphing module 362 selects the lead singer's voice and morphs the lead singer's voice to sound like the target voice.

Recognizing dialect is slightly different, as to do such requires that characters and words from the source audio files 300 be recognized and replaced with words of the dialect of the target voice. In embodiments in which dialect is morphed, the target library 315 includes key dialect words as captured from the sample 310 of the target voice (for example, “ruf” as discussed above). In such, the morphing module 362 has a dialect module 364 that continuously performs a transformation from speech to text through voice recognition, looking for dialect words (e.g. “roof”). When an utterance of a dialect word is found (e.g. “roof”), it is replaced by an utterance of the dialect words as captured from the sample 310 of the target voice (e.g. “ruf”). The frequency and amplitude of the replaced utterance (e.g. “ruf”) is made to approximate the frequency and amplitude of the utterance of the dialect word (e.g. “roof”). So, for example, if the song is “Up on the Roof,” the morphed version of the song will sound like, “Up on the Ruf.” It is anticipated that the replaced utterance will not occupy exactly the same amount of time and, therefore, creative patching of the utterance of the dialect word is made to properly position the shorter replaced utterance or to elongate or shorten the replace utterance.

The morphing engine 362 saves the morphed audio file 300A, for example, in the user data area 502 or any suitable storage.

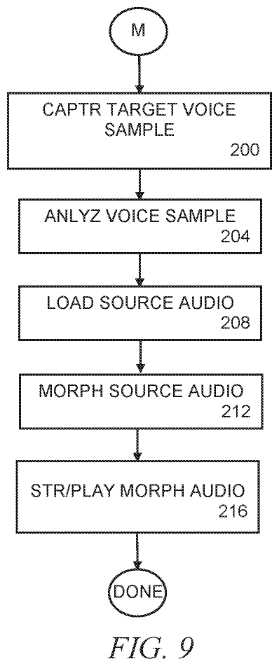

Referring now to FIG. 9, an exemplary program flow of the system for morphing audio is shown. The system for morphing audio captures (or loads) 200 sample 310 of the target voice then analyzes 204 the sample 310 of the target voice to create the target library 315, then the morphing module 362 reads 208 and morphs 212 the source audio files 300, creating (or playing) 216 the new, morphed audio file 300A.

It is fully anticipated that the described content morphine system be applied to video as well. In such, in some embodiments, the audio track of a movie is analyzed and morphed to change the vocal qualities of one actor so the actor then sounds like the target voice. In this embodiment, the above steps are taken but the morphing module 362 requires a voice recognition module to determine when the desired actor is speaking. In this way, only one actor in the movie is morphed to sound like the target voice. For example, a husband and wife can watch “Father of the Bride” with the husband's voice being the target voice of the father and the wife's voice being the target voice of the mother.

It is further fully anticipated that the morphing module 362 also modify the video content using facial recognition. In the example above, when the father's face is shown, facial recognition determines that this is the face of the father and the morphing module 362 replaces the face of the father with the face of the husband and likewise for the wife. It is fully anticipated that the face is appropriately sized, shaded, tinted, and tilted to match the face of the actor that is being replaced. For such, one or more facial images are captured of the target face from one or more perspectives.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for morphing an audio track, the system comprising:
a processor;
software running on the processor obtains a target audio containing voice samples of a target voice, the software analyzes the target audio and creates a target library;
after the software creates the target library, the software loads a source audio file and the software, using the target library, morphs a voice from the source audio file into a morphed voice of the target voice and replaces the voice from the source file with the morphed voice of the target voice, creating a morphed audio file; and
the software saves the morphed audio file into a storage associated with the processor.

2. The system for morphing the audio track of claim 1, wherein if the software recognizes more than one voice in the source audio file, the software selects a lead singer's voice from the more than one voice and the software morphs the voice of the lead singer into the morphed voice of the target voice.

3. The system for morphing an audio track of claim 1, wherein if the software recognizes more than one voice in the source audio file, the software obtains an input indicating with of the more than one voice is to be morphed and the software morphs the voice of the selected voice into the morphed voice of the target voice.

4. The system for morphing an audio track of claim 1, wherein the software recognizes dialects from the target voice and upon finding such dialects in the source audio file, the software morphs the dialects from the source audio file into the dialects of the target voice.

5. The system for morphing an audio track of claim 1, wherein the morphing comprises modification of a tonal quality, a distortion, a fuzziness, a frequency range, an amplitude range, a mean/mode of typical vocal frequency range and amplitude range, a measured target dialect, and a pronunciation of the voice in the source audio file to sound like the target voice.

6. A method of morphing a source audio file, the method comprising:
analyzing a target voice to create a target library;
finding a voice within the source audio file and morphing the voice using the target library so that the voice sounds like the target voice to create a morphed audio file; and
saving the morphed audio file.

7. The method of claim 6, wherein the voice is a lead singer's voice.

8. The method of claim 6, wherein if it is detected that there exist a plurality of voices within the source file, the voice is selected based upon a user input to be one of the plurality of voices within the source file.

9. The method of claim 6, wherein upon recognizing dialects from the target voice and upon finding such dialects in the voice, morphing the dialects from the voice into the dialects of the target voice.

10. The method of claim 6, wherein the morphing comprises modifying of one or more of a tonal quality, a distortion, a fuzziness, a frequency range, an amplitude range, a mean/mode of typical vocal frequency range and amplitude range, a measured target dialect, and a pronunciation of the voice to sound like the target voice.

11. Program instructions tangibly embodied in a non-transitory storage medium of a computer for morphing a source audio file into a morphed audio file, wherein the at least one instruction comprises:
computer readable instructions running on the computer analyze a target voice to create a target library;
the computer readable instructions running on the computer find a voice within the source audio file and morphs the voice using the target library so that the voice sounds like the target voice to create the morphed audio file; and
the computer readable instructions running on the computer saves the morphed audio file.

12. The program instructions tangibly embodied in a non-transitory storage medium of claim 11, wherein the voice is a lead singer's voice.

13. The program instructions tangibly embodied in a non-transitory storage medium of claim 11, wherein if the computer readable instructions running on the computer detect that there exist a plurality of voices within the source file, the computer readable instructions running on the computer select the voice based upon a user input to be one of the plurality of voices within the source file.

14. The program instructions tangibly embodied in a non-transitory storage medium of claim 11, wherein upon if the computer readable instructions running on the computer recognizes dialects from the target voice and when the computer readable instructions running on the computer find such dialects in the voice, the computer readable instructions running on the computer morphs the dialects from the voice into the dialects of the target voice.

15. The program instructions tangibly embodied in a non-transitory storage medium of claim 11, wherein the computer readable instructions running on the computer morphs by modifying one or more of a tonal quality, a distortion, a fuzziness, a frequency range, an amplitude range, a mean/mode of typical vocal frequency range and amplitude range, a measured target dialect, and a pronunciation of the voice to sound like the target voice.
